(19) United States
(12) Patent Application Publication
(10) Pub. No.: US 2010/0185907 A1
(43) Pub. Date: Jul. 22, 2010

(54) METHOD FOR BOUNDS TESTING IN SOFTWARE

(75) Inventor: Charles D. Kunzman, Oakland, CA (US)

Correspondence Address: OSHA LIANG LLP/Oracle, TWO HOUSTON CENTER, 909 FANNIN, SUITE 3500, HOUSTON, TX, 77010, US

(73) Assignee: SUN MICROSYSTEMS, INC., Santa Clara, CA (US)

(21) Appl. No.: 12/355,062

(22) Filed: Jan. 16, 2009

(51) Int. Cl. G06F 11/07

(52) U.S. Cl. 714/722; 714/819; 714/E11.024

(57) ABSTRACT

A method for a bounds test includes receiving a base value, a size value, and a test value; subtracting the base value from the test value to generate a result value in a signed format; comparing the result value and the size value, and passing the bounds test when the size value exceeds the result value interpreted as an unsigned value. A computer readable medium stores instructions for a bounds test, the instructions for causing a computer to perform: receiving a base value, a size value, and a test value; subtracting the base value from the test value to generate a result value in a signed format; comparing the result value and the size value; and passing the bounds test when the size value exceeds the result value interpreted as an unsigned value. A bounds test system includes a processor, wherein the processor supports two's-compliment notation; and a memory, operatively connected to the processor. The memory comprises instructions for causing the processor to perform: receiving a base value, a size value, and a test value; subtracting the base value from the test value to generate a result value in a signed format; comparing the result value and the size value; and passing the bounds test when the size value exceeds the result value interpreted as an unsigned value. The comparing uses an unsigned result value and two's-compliment notation is used for subtracting and comparing.

### BACKGROUND

Bounds testing is a common occurrence in many instances in modern computers. Traditionally, bounds testing involves separately checking both the lower and the upper bounds to ensure that the value to be checked is within the accepted range. Due to the frequency of bounds tests, any improvement in the methodology can have a significant improvement on the efficiency of modern processors.

### SUMMARY

In one aspect, embodiments of the invention relate to a method for a bounds test comprising: receiving a base value, a size value, and a test value; subtracting the base value from the test value to generate a result value in a signed format; comparing the result value and the size value, wherein comparing uses the result value interpreted as an unsigned value; and passing the bounds test when the size value exceeds the result value, wherein the result value is interpreted as an unsigned value, wherein two's-compliment notation is used for subtracting and comparing.

In one aspect, embodiments of the invention relate to a bounds test system, comprising: a processor, wherein the processor supports two's-compliment notation; and a memory, operatively connected to the processor, wherein the memory comprises instructions for causing the processor to perform: receiving a base value, a size value, and a test value; subtracting the base value from the test value to generate a result value in a signed format; comparing the result value and the size value, wherein comparing uses the result value interpreted as an unsigned value; and passing the bounds test when the size value exceeds the result value, wherein the result value is interpreted as an unsigned value, wherein two's-compliment notation is used for subtracting and comparing.

In one aspect, embodiments of the invention relate to a computer readable medium storing instructions for a bounds test, the instructions for causing a computer to perform: receiving a base value, a size value, and a test value; subtracting the base value from the test value to generate a result value in a signed format; comparing the result value and the size value, wherein comparing uses the result value interpreted as an unsigned value; and passing the bounds test when the size value exceeds the result value, wherein the result value is interpreted as an unsigned value, wherein two's-compliment notation is used to subtract and compare.

Other aspects and advantages of the invention will be apparent from the following description and the appended claims.

### BRIEF DESCRIPTION OF DRAWINGS

FIG. 1 shows a system in accordance with one or more embodiments of the invention.

FIG. 2 shows a flowchart of a method in accordance with one or more embodiments of the invention.

FIGS. 3A-3C show examples in accordance with one or more embodiments of the invention.

FIG. 4 shows a diagram of a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a system and method for bounds testing in software. Specifically, in one or more embodiments of the invention, the method uses two's compliment signed and unsigned notation to simultaneously test upper and lower bounds. This results in fewer instructions to execute for bounds testing, and fewer branch statements. These results improve the execution speed and cache efficiency of processors.

A brief explanation of two's compliment notation will be given, as a minimal understanding of the notation is essential to understanding the invention. Two's compliment notation is a method of representing signed numbers in binary. Primarily, a negative number is represented by a 1 in the most significant bit (i.e., the leftmost bit). For the purposes of the invention, what is significant about this notation is that a negative number in two's compliment notation, when treated as a “normal” (i.e., unsigned) binary number is that it is always larger than the biggest possible positive number (represented in two's compliment notation) for the same number of bits. That is, using 4 bits, two's compliment notation can represent numbers from −8 to 7. However, the unsigned binary value of −1 is 15, far larger than can be represented in two's compliment signed notation. The specific details of how two's compliment works with relation to addition, subtraction, and conversion to/from the notation is not needed for understanding the present invention. A table of a few two's compliment binary numbers with 4 bits and their corresponding values in decimal is provided below.

| Binary Representation | Decimal Value |
|---|---|
| 0111 | 7 |
| 0001 | 1 |
| 0000 | 0 |
| 1111 | −1 |
| 1000 | −8 |

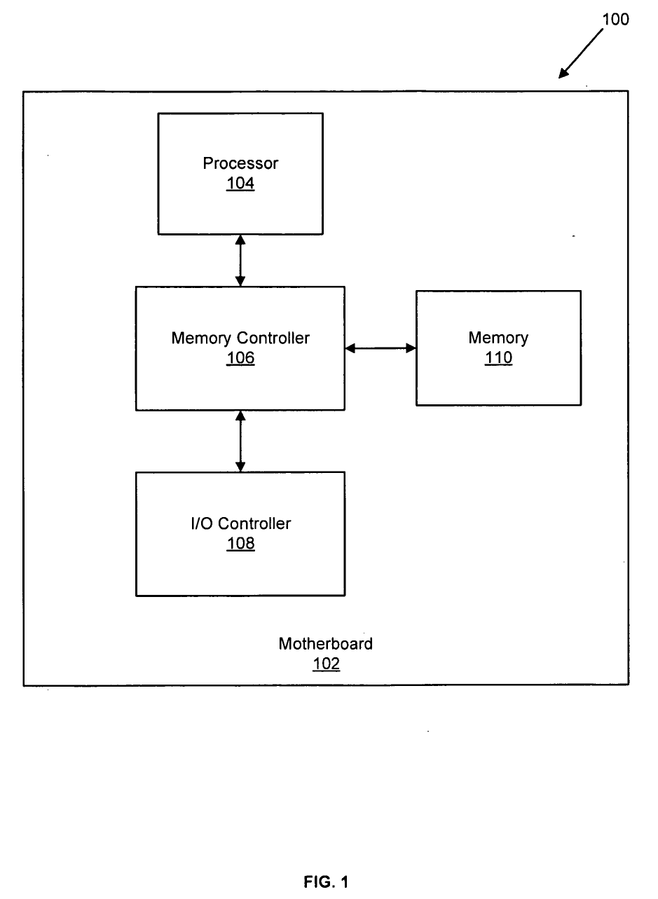

FIG. 1 shows a system in accordance with one or more embodiments of the invention. As shown in FIG. 1, the system (100) includes a motherboard (102), which includes processor (104), memory controller (106), I/O controller (108), and memory (110). Motherboard (102) may be any motherboard. In one or more embodiments of the invention, motherboard (102) may or may not have integrated components such as a video card (not shown). Processor (104) may be any device capable of executing instructions. Memory controller (106) may be any chip capable of managing the flow into and/or out of memory (110). I/O controller (108) may be any chip able to connect to and control peripheral devices (not shown). Memory (110) may be any device capable of storing data.

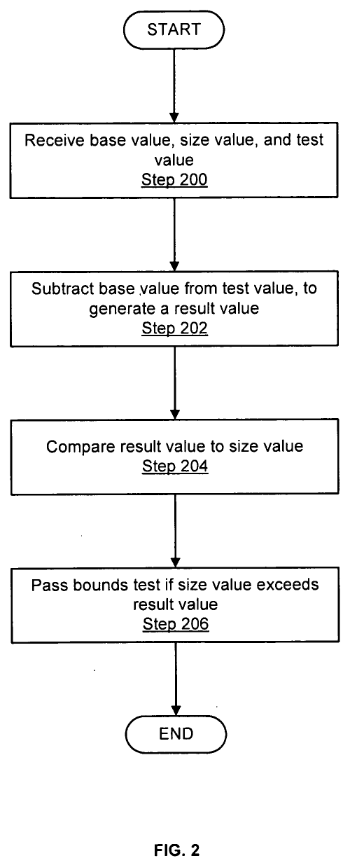

FIG. 2 shows a flowchart of a method for bounds testing in software. The method of FIG. 2 may be implemented, for example, using the system of FIG. 1. In one or more embodiments of the invention, one or more of the steps shown in FIG. 2 may be omitted, repeated, and/or performed in a different order than the order shown in FIG. 2. Accordingly, the scope of the invention should not be considered limited to the specific arrangement of steps shown in FIG. 2.

Initially, in Step 200, a base value, a size value, and a test value are received in accordance with one or more embodiments of the invention. In one or more embodiments of the invention, the values may be received from an operating system. Alternatively, the values may be received from a user program, user input, or any other source. In one or more embodiments of the invention, the values received may be for checking that a guest user within an operating system is within an assigned memory limit. In one or more embodiments of the invention, the values received may be a virtual address that represent a physical address. In one or more embodiments of the invention, the values may be received in two's-compliment notation. Alternatively, the values may be received in another notation.

In Step 202, the base value is subtracted from the test value, thereby generating a result value, in accordance with one or more embodiments of the invention. In one or more embodiments of the invention, the result value is generated in a signed format. Specifically, the signed format may be two's-compliment notation.

In Step 204, the result value is compared to the size value in accordance with one or more embodiments of the invention. In one or more embodiments of the invention, the comparison may use an unsigned notation. For example, the comparison may use unsigned two's compliment notation, thereby causing any negative result value to be much larger than the size value.

In Step 206, the boundary test is passed if the size value exceeds the result value, in accordance with one or more embodiments of the invention. It will be apparent to one of ordinary skill in the art that this method of boundary testing uses a minimal amount of comparisons, thereby reducing the total number of steps for execution, and reducing the number of branch statements. These results provide for more efficient and faster execution of boundary tests.

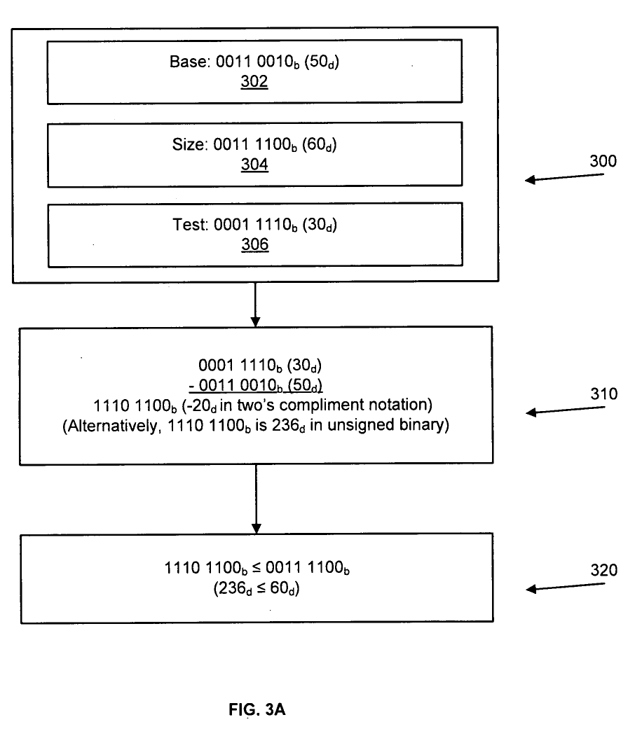

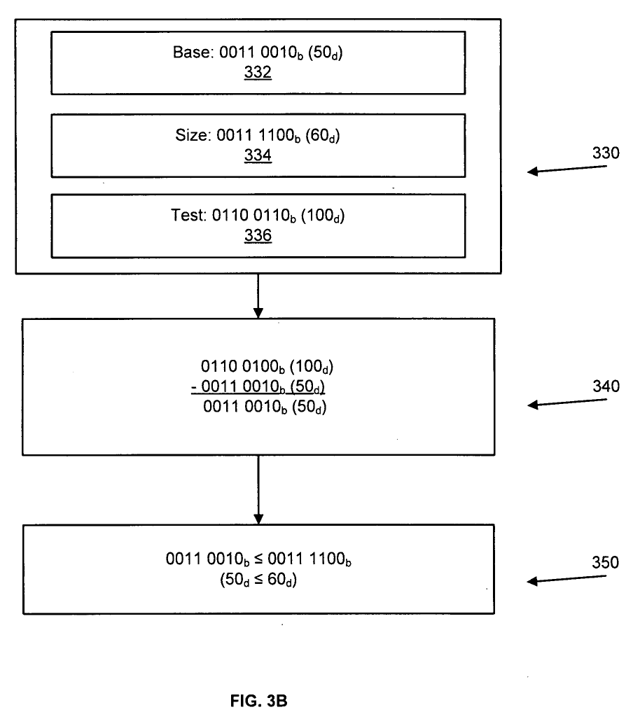

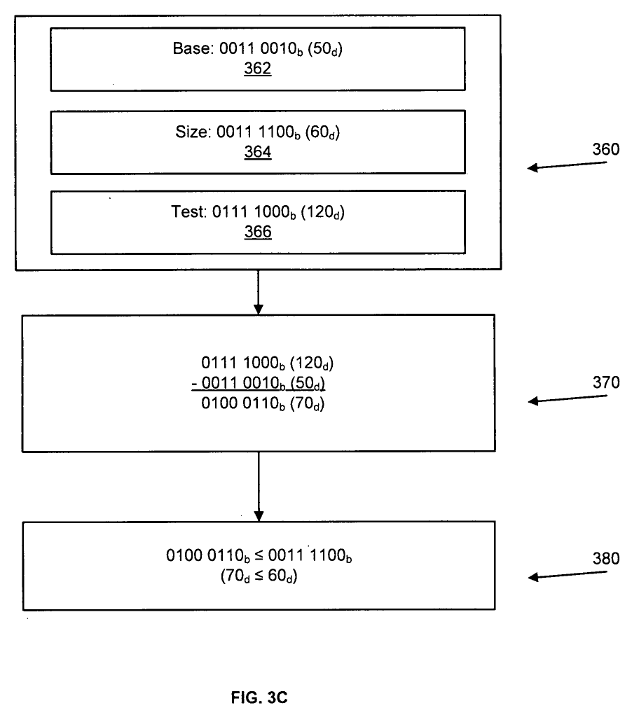

FIGS. 3A-3C show examples in accordance with one or more embodiments of the invention. Specifically, FIGS. 3A-3C show three different boundary tests. In the following examples, for the ease of the reader, the values are displayed in both binary (denoted by a subscript b) and decimal (denoted by a subscript d). Additionally, the examples uses only 8 bits for simplicity, however, any number of bits may be used. It will be apparent to one of ordinary skill in the art that many different values may be used for boundary tests, and the invention should not be limited to the examples discussed below.

Referring to FIG. 3A, in the first step (300), the values for base (302), size (304), and test (306) are received. In this example, the base (302) is 50, the size (304) is 60, and the test (306) is 30. In the second step (310), the base (302) is subtracted from the test (306) to give a result value (not shown). As discussed above, this step uses signed binary notation so that negative values may be correctly represented. The result is 1110 1100_{b}. In two's-compliment signed notation this result is equal to −20_{d}. In unsigned notation this result is equal to 236_{d}. In the third step (320) the result is compared to the size (304). For this step, the unsigned binary value of the result (i.e., 236_{d}, not −20_{d}) is used. Thus, the comparison is 236≦60. Because the result exceeds the size (304), the boundary test fails. In actuality, the boundary test fails because the test (306) is below the base (302) (i.e., 30 is lower than the lower boundary, 50) but, due to the use of unsigned two's-compliment notation, this is represented as exceeding the size (304).

Referring to FIG. 3B, in the first step (330), the values for base (332), size (334), and test (336) are received. In this example, the base (332) is 50, the size (304) is 60, and the test (306) is 100. In the second step (340), the base (332) is subtracted from the test (336) to give a result value (not shown). As discussed above, this step uses signed binary notation so that negative values may be correctly represented. The result is 0011 0010_{b}, or 50_{d}. In the third step (350) the result is compared to the size (334). For this step, the unsigned binary value of the result is used (because the value is positive, using unsigned notation does not change the value). Thus, the comparison is 50≦60. The statement is true, and therefore the boundary test succeeds.

Referring to FIG. 3C, in the first step (360), the values for base (362), size (364), and test (366) are received. In this example, the base (362) is 50, the size (364) is 60, and the test (366) is 120. In the second step (370), the base (362) is subtracted from the test (366) to give a result value (not shown). As discussed above, this step uses signed binary notation so that negative values may be correctly represented. The result is 0100 0110_{b}, or 70_{d}. In the third step (380) the result is compared to the size (364). For this step, the unsigned binary value of the result is used (because the value is positive, using unsigned notation does not change the value). Thus, the comparison is 70≦60. The statement is false, and therefore the boundary test fails.

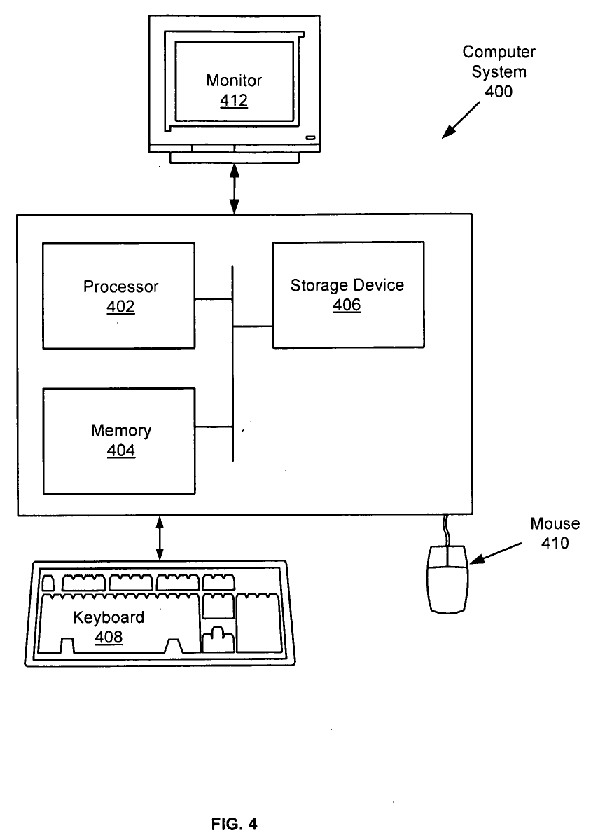

The invention may be implemented on virtually any type of computing device regardless of the platform being used. For example, as shown in FIG. 4, a computer system (400) includes a processor (402), associated memory (404), a storage device (406), and numerous other elements and functionalities typical of today's computers (not shown). The computer (400) may also include input means, such as a keyboard (408) and a mouse (410), and output means, such as a monitor (412). The computer system (400) is connected to a local area network (LAN) or a wide area network (e.g., the Internet) (not shown) via a network interface connection (not shown). Those skilled in the art will appreciate that these input and output means may take other forms, now known or later developed.

Further, those skilled in the art will appreciate that one or more elements of the aforementioned computer system (400) may be located at a remote location and connected to the other elements over a network. Further, the invention may be implemented on a distributed system having a plurality of nodes, where each portion of the invention (e.g., intrusion detection system, response rewriter, server, client) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a tangible computer readable medium such as a digital video disc (DVD), compact disc (CD), a diskette, a tape, or any other suitable tangible computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for a bounds test comprising:
receiving a base value, a size value, and a test value;
subtracting the base value from the test value to generate a result value in a signed format;
comparing the result value and the size value, wherein comparing uses the result value interpreted as an unsigned value; and
passing the bounds test when the size value exceeds the result value, wherein the result value is interpreted as an unsigned value,
wherein two's-compliment notation is used for subtracting and comparing.

2. The method of claim 1, wherein the base value, the size value, and the test value are received in two's-compliment notation.

3. The method of claim 1, wherein the base value, the size value, and the test value are received in one's-compliment notation.

4. The method of claim 3 further comprising:
converting the base value, the size value, and the test value to two's-compliment notation.

5. The method of claim 1 further comprising:
failing the bounds test when the unsigned result value exceeds the size value.

6. The method of claim 1, wherein the bounds test is for checking that a user of a system is within an assigned memory limit.

7. The method of claim 1, wherein the bounds test checks a virtual address that represents a physical addresses.

8. A bounds test system, comprising:
a processor, wherein the processor supports two's-compliment notation; and
a memory, operatively connected to the processor, wherein the memory comprises instructions for causing the processor to perform:
receiving a base value, a size value, and a test value;
subtracting the base value from the test value to generate a result value in a signed format;
comparing the result value and the size value, wherein comparing uses the result value interpreted as an unsigned value; and
passing the bounds test when the size value exceeds the result value, wherein the result value is interpreted as an unsigned value,
wherein two's-compliment notation is used for subtracting and comparing.

9. The system of claim 8, further comprising:
an input device.

10. A computer readable medium storing instructions for a bounds test, the instructions for causing a computer to perform:
receiving a base value, a size value, and a test value;
subtracting the base value from the test value to generate a result value in a signed format;
comparing the result value and the size value, wherein comparing uses the result value interpreted as an unsigned value; and
passing the bounds test when the size value exceeds the result value, wherein the result value is interpreted as an unsigned value,
wherein two's-compliment notation is used to subtract and compare.

11. The computer readable medium of claim 10, wherein the base value, the size value, and the test value are received in two's-compliment notation.

12. The computer readable medium of claim 10, wherein the base value, the size value, and the test value are received in one's-compliment notation.

13. The computer readable medium of claim 12, further comprising instructions with functionality to:
convert the base value, the size value, and the test value to two's-compliment notation.

14. The computer readable medium of claim 10, further comprising instructions with functionality to:
fail the bounds test when the unsigned result value exceeds the size value.

15. The computer readable medium of claim 10, wherein the bounds test is for checking that a user of a system is within an assigned memory limit.

16. The computer readable medium of claim 10, wherein the bounds test checks a virtual address that represents a physical addresses.
